(19) United States
(12) Patent Application Publication
(10) Pub. No.: US 2002/0046204 A1
(43) Pub. Date: Apr. 18, 2002

(54) Heuristic automated method for ideal bufferpool tuning in a computer database

(76) Inventor: Scott R. Hayes, Wake Forest, NC (US)

Correspondence Address: GREENWALD & BASCH, LLP, SUITE 2490, 349 WEST COMMERCIAL STREET, EAST ROCHESTER, NY, 14445, US

(21) Appl. No.: 09/938,151

(22) Filed: Aug. 23, 2001

Related U.S. Application Data
(60) Provisional application No. 60/228,200, filed on Aug. 25, 2000.

(51) Int. Cl. G06F 7/00

(52) U.S. Cl. 707/1; 707/104.1

(57) ABSTRACT

The present invention is a method for automating database bufferpool tuning for optimized performance that employs certain heuristic algorithms to achieve its goals. Over a period of time, memory (bufferpool) performance is measured and accumulated in a repository. The repository becomes a knowledge base that is accessed by the algorithms and the ideal memory (bufferpool) configurations, which optimize database performance, are learned and implemented. The sampling of performance continues at regular intervals and the knowledge base continues to grow. As knowledge continues to accumulate, the algorithms are forbidden from becoming complacent. The ideal bufferpool memory configurations are regularly reevaluated to ensure they continue to be optimal given potential changes in the database's use or access patterns.

### BACKGROUND AND SUMMARY OF THE INVENTION

Historically database administrators have had to use guesswork and trial and error to identify the optimal bufferpool settings in a database, and to try and determine the best mix between memory allocation and disk thrashing. A bufferpool setting that works well for one or more jobs may perform sub optimally on other jobs and settings. It is a common practice of database administrators to set higher memory allocations to facilitate best-perceived performance. Moreover, there have not been effective automated methods of auto tuning buffer pool sizes, nor of using the computer itself to record, analyze, visualize and adjust the complex mix of users, databases, related access profiles, and performance.

In many situations, once settings are applied that appear to work reasonably well, even though there may be an over allocation of system resources, the settings may be left alone for lack of an effective means for tuning the bufferspace. Then, if systems resources are constrained, these settings may be cut back, possibly resulting in suboptimal performance conditions. Without an ongoing means of monitoring usage, and the effects of bufferpool modifications on overall system performance across a wide range of users and jobs, it is difficult for today's system administrator to optimize either the system or the system settings.

One possible outcome of the lack of automated bufferpool tuning methods is over allocation of system memory and disk drives, resulting in an impact on system and operating costs. Another outcome of the present situation is poor performance given a system's resource allocation compared to what might be achieved if there were a means of optimization.

Databases today make extensive use of machine memory to improve performance. Sometimes these memory areas are called caches, heaps, and sometimes pools or bufferpools. Most relational database engines make use of all three memory types for the purpose of minimizing input/output (I/O) to disk, which is generally regarded as orders of magnitude slower than accessing data already in memory.

Caches typically store information about data definitions in memory to help the database engine improve performance. Other caches may store information about programs and configuration values. Heaps are typically areas of memory dedicated to resolving temporary or transient program tasks, such as sorting data, joining tables together, materializing views, and other memory work areas required by the database engine to complete its tasks. Bufferpools are areas of memory dedicated to storing user or application data. When a user or application queries the database, the bufferpools are first checked by the database engine to determine if the required data is already resident in memory. This is often referred to as a Logical Read. If the required data is not available in the bufferpools, then the database engine must issue I/O requests to disk to get the required data. This is often referred to as a Physical Read. Physical reads to disk can occur synchronously or asynchronously.

If the physical reads are synchronous, then the user application must wait for the data to be retrieved from disk prior to continuing. Some database engines, like IBM's DB2, also implement asynchronous reads. When the database engine reads data asynchronously, data is pre-fetched into bufferpools typically in advance of the user application's requirement for the data. In this way, when the data is pre-fetched, the user application generally does not experience any I/O delay—even though physical I/O is taking place on its behalf.

Whether to pre-fetch data asynchronously or to read it synchronously is a decision that is made by the database engine optimizer. Most relational database engines, including IBM's DB2, implement advanced optimizer technology that considers the data request, configuration values, and statistical values, and determines the quickest way, or least cost method (in terms of I/O and CPU), of accessing the data.

The distinction between synchronous and asynchronous read operations is important for the purpose of understanding the tuning techniques described herein, and an appreciation of the advantages of the present invention. Hence, the following discussion will elaborate further using examples.

### Synchronous Reads

Consider the telephone operator who is taking a call from a customer. The customer provides its customer number. The operator accesses the database record containing the customer's name and other attributes. A SINGLE, or a very few, record or records is returned from the database to the operator. This type of precise read is typical of Online Transaction Processing (OLTP) applications. It is also typical and expected that the optimizer would choose to perform a SYNCHRONOUS read of the required data (physical read) if it was not already available in the bufferpool (logical read).

### Asynchronous Reads

Consider the marketing analyst who wants to gain a better understanding of the locations of his company's customers. A report showing a breakdown of customers by U.S. State may be useful in determining where to best spend advertising dollars. This is a Decision Support Services (DSS) query. This type of query typically needs to access the entire database (versus a single or limited set of records), and it is generally expected that the optimizer would choose to pre-fetch the required data via asynchronous reads into the bufferpools. Assuming the data is distributed across multiple disks/storage devices, the database engine will generally invoke multiple asynchronous pre-fetch tasks, in parallel, to bring the data into memory as fast as possible where it can be tabulated by the database engine.

The distinction between synchronous versus asynchronous is important because the tuning method for bufferpools must vary based on the predominant type of data access.

Appropriately sized bufferpools can substantially improve the performance of database queries by eliminating or reducing physical reads to disk. The more frequently data requests can be satisfied from memory instead of via disk access, the better performance will generally be for applications that read data precisely (OLTP type) and, to a lesser extent, for applications that read large volumes of data (DSS type).

OLTP type applications which request specific or small sets of records from the database tend to benefit the most from larger bufferpools because the most frequently accessed data has the opportunity to remain resident in the pool, and thus be satisfied by logical reads only. When the application requests data, and the data is already resident in a bufferpool (logical read), this is called a “hit”. When a logical read results in a physical read, this may be thought of as a “miss”. The proportion of times that physical reads occurred to satisfy logical reads represents the “miss ratio”. The proportion of times that data requests were satisfied entirely by logical reads represents the “hit ratio”. Because physical I/O is costly to elapsed time, it follows that the higher the “hit ratio” the better expected performance of the database system. This principle is widely accepted within the database community.

Miss Ratio=Number physical reads/Number Logical Reads Eq. 1

Hit Ratio=100−(Number physical reads/Number Logical Reads) Eq. 2

A Bufferpool's hit ratio is, therefore, a very important measurement of its effectiveness in terms of its contribution to benefiting database performance. Furthermore, relational databases often implement index data structures to speed access to data stored therein. These index structures commonly contain key values and pointers to data containing those key values. Indices are typically much smaller in size than the data from which they relate, and they are often frequently accessed. Hence, the hit ratio can be, and should be, further broken down into measurements of INDEX hits and OVERALL hits.

BTREE index structures employ a top most “root” page of index entries that reference one or more tiers of non-leaf pages. Non-leaf pages provide pointers to leaf pages, and index leaf pages ultimately provide pointers to the actual database data pages containing the requested data. It is common for BTREE indexes to have two to five levels. It is important to measure the Index Hit Ratio separately from the Overall Hit Ratio of a bufferpool because indexes generally provide substantial performance improvement to record access. By keeping as many levels of index pages in bufferpool memory as possible, access to underlying database records will be greatly improved.

Consider that the average time, to read a page of information from disk (physical read) is, for example, four milliseconds. If an index has four levels (one root page, two non-leaf levels, and a leaf page level), it could take up to five physical I/O operations to traverse the entire structure (four I/Os to the index and an I/O to the data). Thus access to a database could require approximately 20 milliseconds (5×4 milliseconds). If all four of the index pages were resident in the bufferpool and could be satisfied by logical reads (100% Index Hit Ratio), it might take only a single physical I/O, or four milliseconds, to access the required data. Thus, by maximizing bufferpool hit ratios, elapsed time to execute user application data requests can be significantly reduced.

DSS type database queries that request large volumes of records from the database do not benefit from ever increasingly larger bufferpools. First, the likelihood that the data will be re-read is minimal. Second, the large numbers of data records retrieved from disk and placed into the pools tends to rapidly displace previously read data. It is for this reason (data displacement effect), that database administrators will commonly separate OLTP and DSS functions into separate bufferpools, physical space allocations, or databases (OLTP is then isolated from the effects of DSS I/O). Third and finally, because the data is rarely re-read (negating the value of high hit ratios), the most important factor in tuning DSS (predominantly asynchronously read) bufferpools tends to be providing sufficient pool size to accommodate the rate of asynchronous data delivery. It is also important to note that indexes are generally less frequently utilized in a DSS database, or, if they are employed and used by the optimizer, then the indexes tend to be pre-fetched (also called “scanned”) as with the actual data.

In terms of bufferpool tuning then, characteristics of OLTP versus DSS type access are quite different and have different tuning objectives. A good relational database engine will provide extensive reporting as to the types and numbers of I/O operations that are being performed. To effectively tune bufferpools, it is imperative to know: the following:

the number of logical data reads;

the number of logical index reads;

the number of physical data reads (total);

the number of physical index reads (total);

the number of asynchronous data reads; and

the number of asynchronous index reads. Based upon the performance counters above, it is possible to compute:

Index Hit Ratio;

Overall Hit Ratio;

Percentage of Asynchronous Reads; and

Percentage of Synchronous Reeds.

If the percentage of Synchronous reads is high, the nature of the data access is typically representative of OLTP application environments—highly random, and selective in nature. For these types of applications, it is important to optimize for the Index Hit Ratio as this will yield the best performance by eliminating the most I/O.

On the other hand, if the percentage of Synchronous reads is low to modest, then access to the data in the bufferpool is more sequential and intensive in nature. In a highly asynchronous application environment, it is important to optimize the overall hit ratio for the bufferpool. The reason, of course, is that index pages will tend to be frequently flushed out of the buffers; that is, if they are even utilized at all.

In summary, bufferpool tuning is critically important to achieving optimized database performance, but must be done with knowledge of the access type that is prevalent. In other words, the nature of data access must determine the tuning approach. Generally, the better the bufferpool hit ratios, the better the application performance.

In response, it may be posited that if ever-increasing bufferpool sizes generally result in better hit ratios and better performance, why not increase bufferpool sizes infinitely? The answer is that, because bufferpools must be substantiated by real memory (RAM) available to the processor, increasing the bufferpool beyond a reasonable size is cost prohibited. When the demand for memory on the machine exceeds the available real memory, the operating system begins a process of paging, which manages the contents of real memory. Most operating systems implement some form of paging process. When a system pages, the contents of real memory are moved back and forth between memory and disk. When paging is excessive (resulting in many disk I/Os), performance of the entire machine typically degrades substantially. Therefore, when tuning bufferpools, it is important to constrain growth to sizes that can be accommodated by the real memory available on the machine. The presence of paging must act as a bufferpool growth inhibitor, or any benefits of reduced bufferpool disk I/O will be diminished due to paging disk I/O. In general, of all forms of I/O in most operating systems, paging I/O is widely considered to be the worst type since the degradation will be indiscriminate across all machine processes.

Heretofore, U.S. Pat. No. 5,440,692 taught methods of dynamically expanding and contracting the size of DB2 Bufferpools for the IBM MVS Operating System. However, the patent fails to provide for or suggest determining the ideal sizes of these pools for achieving the optimal performance and hardware resource utilization. Moreover, the patent is directed to the IBM mainframe DB2 environment, whereas the current invention is broadly applicable to database management systems in general.

An object of the present invention, therefore, is to automate the optimization of bufferpool tuning in a computer database. Another object of the invention is the optimization over time, taking into account performance heuristics and load variances. Another object is to provide automated, ongoing re-tuning to continue the optimization and to account for performance changes and anomalies. A further object of the invention is to enable optimization where the optimization further ensures that the optimization algorithms do not become complacent. Yet a further object of the invention is to require minimal intervention from administrative staff. Still yet another object of the, invention is to remove a barrier to optimal database performance by deploying a self-learning, automated process. Another object of the invention is to optimize usage between synchronous read, asynchronous reads, and combinations of usage. Yet another object of the invention is to provide reporting on the types and numbers of I/O being performed and the use of such information over time (history) for optimization. A further object of the invention is to adjust the bufferpool size setting based on the Index Hit Ratio to yield the best performance by eliminating the most I/O.

In accordance with the present invention, there is provided a heuristic method for the automated tuning of bufferpool size in a computer database, comprising the steps of: automatically characterizing the types of database access; automatically collecting data base access and usage data based upon a predefined schedule; and using the types of database access characterized and database access and usage data, optimizing the allocation of bufferpool memory so as to ensure optimal access time and to minimize disk thrashing.

In accordance with another aspect of the present invention, there is provided a heuristic method for automated bufferpool tuning in a computer, comprising the steps of: automatically identifying types of access; automatically recalibrating the bufferpool sized based upon historical data, including time of day and day of week usage patterns stored in a historical usage database; and optimizing the allocation of computer memory to ensure optimal access time.

In accordance with yet another aspect of the present invention, there is provided in a database, a bufferpool tuning process, comprising the steps of: deploying self-executing program to monitor and collect data relating to the performance of a database bufferpool, including access data and tablespace size; combining the tablespace size and access attributes, to track historical performance; and tuning the bufferpool in response to the historical performance.

One aspect of the invention deals with a basic problem in bufferpool optimization—determining optimized sizes for database bufferpools. The present invention addresses such a problem and uses learned performance experiences and data access characteristics (sequential vs. random) so as to dynamically monitor and adjust bufferpool sizes.

This aspect is further based on the discovery of a technique that alleviates this problem. The technique includes the steps of: automatic identification of types of database access to enable optimal bufferpool settings; automatic recalibration to ensure optimization for varying usage patterns and users so as to ensure optimal time and minimal disk thrashing; determining the optimal settings for INDEX hits and OVERALL hits; adjusting for variances between characteristics of OLTP and DSS type access; and determining which objects to put into which bufferpools. The techniques described herein are advantageous because they optimize the bufferpools for specific jobs and users, and/or at specific times and usage patterns. In addition, the method employs an algorithm that combines a tablespace size and performance attributes, charts historical performance, and tunes the bufferpools. In addition, it can be used to analyze optimal bufferpooling for the specific users, jobs, and data elements being accessed at any finite point in time. The techniques of the invention are advantageous because they overcome the limitation of human administrator adjustments which may miscalculate a situation and apply suboptimized settings and then not notice and readjust due to lack time, shift changes, etc. By using an iterative cybernetic algorithm, optimization of both bufferpool and performance can be-continual measured, tuned and refined

### BRIEF DESCRIPTION OF THE DRAWINGS

FIGS. 1-4 are sections of a flowchart depicting a series of steps performed in accordance with an embodiment of the present invention.

The present invention will be described in connection with a preferred embodiment, however, it will be understood that there is no intent to limit the invention to the embodiment described. Specific details disclosed herein are not to be interpreted as limiting, but rather as a basis for the claims and as a representative basis for teaching one skilled in the art to employ the present invention in virtually any appropriately detailed system, structure or manner. On the contrary, the intent is to cover all alternatives, modifications, and equivalents as may be included within the spirit and scope of the invention as defined by the appended claims.

### DESCRIPTION OF THE PREFERRED EMBODIMENT

For a general understanding of the present invention, reference is made to the drawings. In the drawings, like reference numerals have been used throughout to designate identical elements. In describing the present invention, the following term(s) have been used in the description.

“Memory” is any circuitry that can store data, and may include local and remote memory and input/output devices. Examples include semiconductor ROMs, RAMs, and storage medium access devices with data storage media that they can access. A “memory cell” is memory circuitry that can store a single unit of data, such as a bit or other n-ary digit or an analog value.

A “cache” is an area of memory (e.g., in a database) storing attribute information about the database, its objects, and potentially programs. A “heap” is an area of database memory typically dedicated to temporary work space. Sorts, joins, and other transient database operations are performed in heaps, then heaps are re-used on a subsequent transient request. A “bufferpool” is an area of memory that stores user application data such as names and addresses. Bufferpools are used to improve performance by reducing I/O requests to disk devices.

A “logical read” occurs when the database engine accesses its bufferpool(s) to retrieve certain data. The requested data may or may not already be present in the bufferpool(s). A “physical read” results when a logical read request to a bufferpool determines that the requested data was not already in the bufferpool. A physical read, or a disk I/O, returns data to the bufferpool so that logical reads can be satisfied. “Synchronous reads” are physical reads that cause the user application to wait until they have completed. Generally, synchronous reads are issued by the database engine to retrieve relatively small numbers of records. “Asynchronous reads” are physical reads that allow user applications to process large volumes of data rapidly without having to wait for their completion.

When a database engine asynchronously reads data, it is said to “pre-fetch” it. The term pre-fetch implies that the data is to arrive in the bufferpools in advance of the user-application's need for it; thus, there is no I/O delay incurred by the user-application.

A measure of a bufferpool's ability to successfully avoid disk I/O is the “Hit Ratio”. The higher the Hit Ratio, generally the better the performance yielded by the database. The “Index Hit Ratio” is a measure of a bufferpool's ability to successfully access Index data without having to issue disk I/O requests. An Overall Index Hit Ratio is a measure of a bufferpool's ability to successfully access Index and Data without having to issue disk I/O requests. The “Percentage of Synchronous Reads” is the proportion of bufferpool read requests that were synchronous, whereas the “Percentage of Asynchronous Reads” is the proportion of bufferpool read requests that were asynchronous.

With a goal of optimizing bufferpool performance with the constraint of avoiding system paging, the following procedure is preferably employed. In describing the procedure, three distinct phases will be described, including:

Phase 1—Monitoring Current Bufferpool Performance;

Phase 2—Archiving current performance results along with configuration values to historical data stores; and

Phase 3—Analyzing the historical data stores and making bufferpool tuning changes based on algorithm results.

### Phase 1

### Monitoring Current Bufferpool Performance

On any given day, during a specified period of time, database bufferpool I/O activity must be monitored for each defined bufferpool in the database. For IBM's DB2 Universal Database, the following command can be used to retrieve information on bufferpool performance from the database engine:

db2 “get snapshot for bufferpools on DBNAME,”

where DBNAME is the name of the database containing the bufferpools to be monitored. Alternatively, DB2 provides other call level interfaces or APIs that can be used to retrieve the same data. An example of the output from this command is provided in Table A.

TABLE A

| | |
|---|---|
| Bufferpool name = | IBMDEFAULTBP |
| Database name = | DBNAME |
| Database path = | /dbO/dbmsil/dbmsil/NODEOQOtj,/5QL00002/ |
| Input database alias = | DBNAME |
| Buffer pool data logical reads = | 7361 |
| Buffer pool data physical reads = | 3914 |
| Buffer pool data writes = | 1885 |
| Buffer pool index logical reads = | 50 |
| Buffer pool index physical reads = | 38 |
| Total buffer pool read time (ms) = | 17458 |
| Total buffer pool write time (ms) = | 654 |
| Asynchronous pool data page reads = | 3901 |
| Asynchronous pool data page writes = | 1885 |
| Buffer pool index writes = | 0 |
| Asynchronous pool index page reads = | 21 |
| Asynchronous pool index page writes = | 0 |
| Total elapsed asynchronous read time = | 15709 |
| Total elapsed asynchronous write time = | 654 |
| Asynchronous read requests = | 498 |
| Direct reads = | 66 |
| Direct writes = | 0 |
| Direct read requests = | 4 |
| Direct write requests = | 0 |
| Direct reads elapsed time (ms) = | 31 |
| Direct write elapsed time (ms) = | 0 |
| Database files closed = | 0 |
| Data pages copied to extended storage = | 0 |
| Index pages copied to extended storage = | 0 |
| Data pages copied from extended | 0 |
| storage = | |
| Index pages copied from extended | 0 |
| storage = | |

Using the results from the performance snapshot, values for the following performance measurements must be calculated:

1. Bufferpool Index Hit Ratio (IHR)

2. Bufferpool Overall Hit Ratio (OHR)

3. Synchronous Read Percent (SRP)

The formula for IHR is:

IHR=(D*100)/(D+E) Eq. 3

where:

D=Buffer pool index logical reads; and

E=Buffer pool index physical reads

Substituting the sample values found in Table A, the IHR for bufferpool IBMDEFAULTBP is:

IHR=50*100/( 50+38)=5000/88=57% Eq. 4

The formula for OHR is:

OHR=((A+D)*1OO)/(B+E+A+D) Eq. 5

where:

A=Buffer pool data logical reads;

B=Buffer pool data physical reads;

D=Buffer pool index logical reads; and

E=Buffer pool index physical reads.

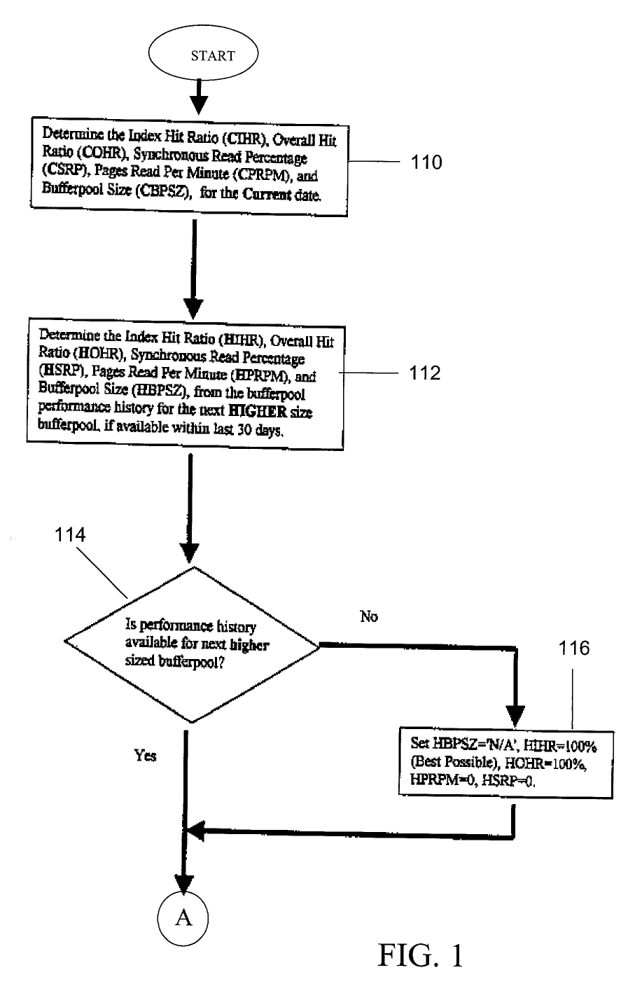

Substituting the sample values found in FIG. 1, the OHR for bufferpool IBMDEFAULTBP is:

OHR=((7361+50)*100)/(3914+38+7361+50)=65% Eq. 6

The formula for SRP is:

SRP=100−((H+K)/((B+E)/100) Eq. 7

Where:

H is equal to the Asynchronous Pool Data Page Reads

K is the Asynchronous Pool Index Page Reads

B is the Bufferpool Data Physical Reads, and

E is the Bufferpool Index Physical Reads.

### Phase 2

### Archiving Current Performance Results Along with Configuration Values to Historical Data Stores

Phase 2 determines the optimal size of the bufferpool, given actual usage history, as defined in more detail in Phase 3. In Phase 2 on a regular, periodic basis, all bufferpool performance data (including all values in Table A) plus all computed performance metrics (for example, Index Hit Ratio, Synch Read Percentage), and current Bufferpool configuration (for example, size and related attributes), must all be saved in a different file or database table for later analysis.

### Phase 3

### Analyzing the Historical Data Stores and Making Bufferpool Tuning Changes Based on Algorithm Results

Phase III provides for continual iteration, over time, to compute the optimal bufferpool size given recent history and to augment or replace the previous bufferpool size/setting, and identify if the system was paging memory, in which case any bufferpool increase can be modified or canceled.

In one embodiment the present invention may be implemented as a method embodied in the form of a software program or code to be performed on computer. An implementation of such a program could be executable on an IBM mainframe or mini-computer machine or equivalent running IBM MVS/ESA, OS/390, AIX, AS/400, OS/2, and IBM Database 2, or an Oracle database, running on any of these aforementioned computers, or Sun Solaris, etc., or on Microsoft Access, or Borland Paradox running on a personal computer, or on any other type of computer systems handling database transactions.

For purposes of further illustration, the present application includes an Appendix having selected source code extracts from an actual software program performing bufferpool management in accordance with the present invention. In the interest of clarity, only selected features of an actual program are included so as to teach a person skilled in the art of computer programming and database management how to create and utilize this function. It should be appreciated that in the development of the embodiment described (as in any software development project), numerous programming decisions must be made to achieve specific goals, and that such goals may vary from one implementation to another. It should be further appreciated that such a development effort might be complex and time-consuming, but would nevertheless be a routine undertaking of system program development for those of ordinary skill having the benefit of this disclosure.

In working' with database tools such as Oracle, IBM DB2, and others, the system administrator sets up the size of the bufferpool based on their best guess for an allocation that provides an efficient use of the current, and comfortably available, RAM and their “wag” (i.e., wild assumed guess) relevant to system optimization. The devoted administrator will then apply his or her skills of observation and experimentation to achieve reasonable performance, and then check the system's performance from time to time to validate or modify the current setting.

Although this approached has seemingly served the industry well for many years, many factors can result in sub-optimization using the standard approach described. For example, certain jobs may run at night, or on weekends, to minimize contention with normal business day users. These jobs may have very different memory allocation optimization parameters than those viewed by the administrator during his or her availability.

Furthermore, even during the course of a normal business day, the nature of the jobs and users on the system at any given time may vary. There may or may not be a pattern to these usage actualities. And, it may or may not be the case that the bufferpool tuning parameters established by the system administrator at any given point of time are, in fact, going to be the ones that are optimal for that job.

Hence, as the flowchart of the heuristic automated bufferpool informed tuning algorithm is now described in detail, the reader will appreciate that the system is designed to store usage data, test for optimization, reset the data, and monitor ongoing operations using cybernetic principles and iteration to ensure maintenance of an optimal bufferpool size. The system further resets itself occasionally to ensure that the bufferpool for the given moment in time is in place, and that the system stores usage patterns by time slices during the day; noting variances from day to day and time to time, so as to establish and take advantage of changing parameters. Accordingly the system preferably learns, over time, the high-probability, optimal settings that might be deployed on any given day, at any given time of day. Moreover, the system may also be employed to learn, over time, the optimal settings for any given user, and any given type of job that is run, enabling, over time, a historical database of usage patterns to be acquired. Once acquired, the system may repeatedly access such data and to refresh and recalibrate in order to ensure that the dynamic bufferpool allocation parameters do not grow stale or inefficient on any dated usage characteristic.

Turning now to the Figures, FIGS. 1-4, depicted therein is a flowchart for an embodiment of the present invention. FIG. 1 depicts the initial steps of a bufferpool tuning algorithm, based on the next higher size pool, if available, within the past thirty days, based on actual usage statistics, and adjusts the bufferpool accordingly. More specifically, beginning with step 110, the process captures bufferpool data for the current date and processes the data to determine heuristics (e.g., Current IHR (CIHR)). Similarly, as represented by Step 112, data and heuristics are determined for prior dates and higher or larger-sized bufferpools—preferably from a historical database. Next, at step 114, a test is performed to determine if bufferpool performance data is available for a next higher bufferpool size. If not, variables are set in step 116 to predetermined levels and processing continues.

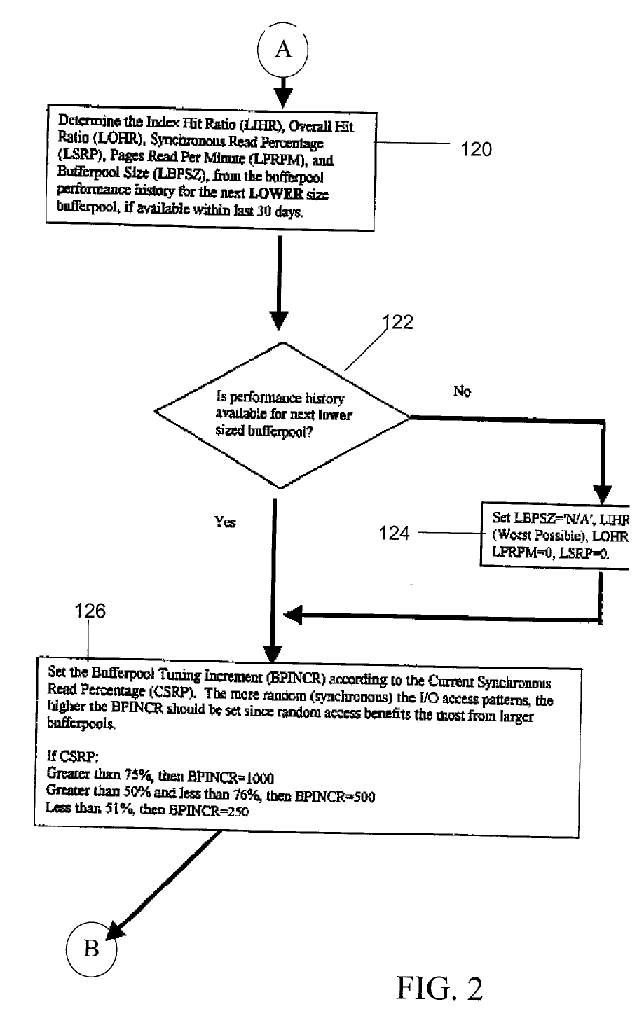

Considering FIG. 2, there are depicted process steps for capturing data for next lower or smaller-sized buffer pools, beginning with step 120. In particular, data is captured for the bufferpool tuning algorithm, based on the next lower size pool, if available, within the past thirty days. The data is preferably based on actual usage statistics, and adjusts the bufferpool accordingly as will be described with respect to step 126. At step 122, as in step 114, a test is performed to determine if performance history data exists for the next lower sized bufferpool. If not, variables are set in step 124 to predetermined levels and processing continues at step 126.

At step 126, the buffer pool tuning increment (BPINCR) is set in response to the synchronous read percentage previously calculated. For example, the more random (synchronous) the I/O access patterns are, the higher the BPINCR should be set so that random access benefits the most from larger bufferpool settings.

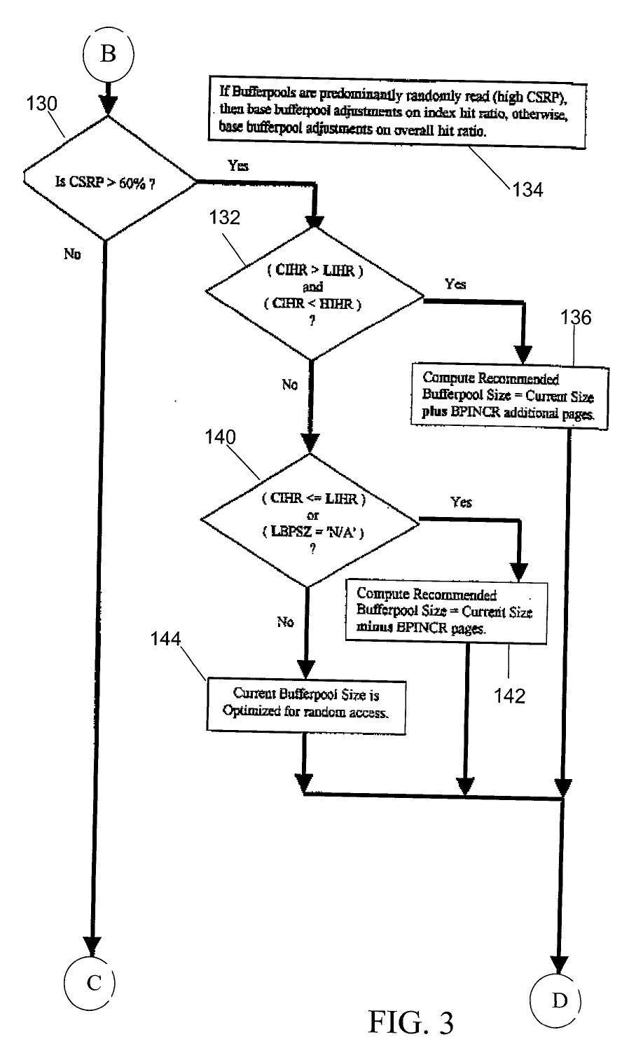

Turning to FIG. 3, the optimal size of the bufferpool is determined using the steps depicted, and is preferably based upon actual usage history. Overall, the tuning operates as described in block 134, where if there is a high CSRP, then the adjustments are in response to the IHR. Otherwise, adjustments are made on OHR. More specifically, in one embodiment, step 130 tests to determine if CSRP is greater than a predetermined threshold (e.g., 60%). Alternatively, the testing may employ multiple thresholds so as to allow bufferpools to have their sizes changed by larger increments of memory, as represented by the following code segment:

```
if [[$csrp −gt 75]] then
  bpincr=2000
elif [[$csrp −gt 50 && $csrp −lt 76]] then
  bpincr=1000
elif [[$csrp −gt 5 && $csrp −lt 51]] then
  bpincr=1000
else
  bpincr=0
fi
```

where a CSRP greater than seventy-five results in a larger increase in bufferpool size than a CSRP greater than five but less than seventy five percent.

If so, processing continues at step 132, where the Current IHR is compared to the Lower and Higher (historical) IHR values from the historical database. An affirmative result from test step 132 will result in processing continuing at step 136, where the recommended bufferpool size is calculated based upon the current size, plus an incremental adjustment equal to the BPINCR number of additional pages and processing is essentially complete. Otherwise, based upon a negative response in step 132, processing continues at step 140 where further testing is conducted on the value of the Current IHR. Again, an affirmative response results in processing being continued at step 142, where the recommended size is computed using the current bufferpool size and taking away BPINCR pages. A negative response to the tests in steps 132 and 140 results in a determination, as indicated by step 144, that the bufferpool is presently optimized for random access.

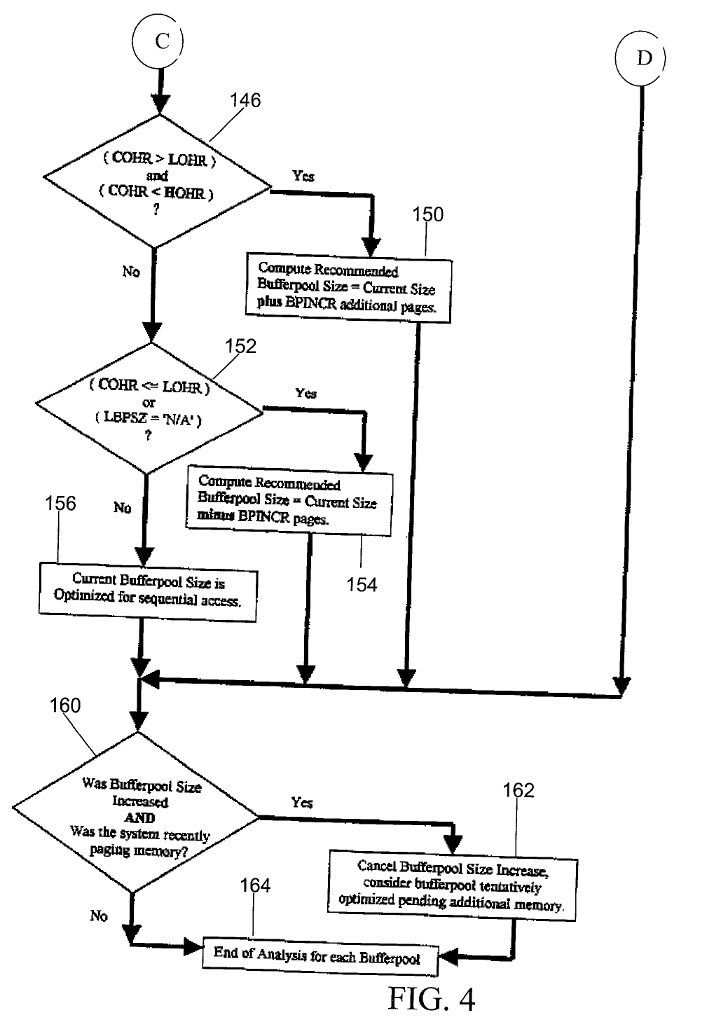

Lastly, turning to FIG. 4, the optimal bufferpool size is calculated for a bufferpool where access is not predominantly random (lower CSRP level). At step 146, the Current OHR is compared to the lower and higher (historical) levels. An affirmative test result causes processing to continue at step 150, where the bufferpool size is set as the current size plus BPINCR pages. Otherwise, the process continues at step 152, where the need for a smaller page number is analyzed, again testing for Current OHR and a variable (LBPSZ) set in step 124. An affirmative result continues processing at step 154, where the bufferpool size is decreased by a number of pages equal to BPINCR. Negative results to the test in steps 146 and 152 results in a determination, as represented by step 156, that the bufferpool size is optimized.

Ultimately, processing continues, for all of the various paths through the flowchart, at step 160, where a final test is employed to determine whether a bufferpool size increase will likely result in additional memory paging (an unacceptable result). If the test in step 160 results in an affirmative, step 162 cancels the size increase and restores the size to the present size, before completing the optimization process as indicated by step 164.

In recapitulation, the present invention is a method for automating database bufferpool tuning for optimized performance that employs certain heuristic algorithms to achieve its goals. Over a period of time, memory (bufferpool) performance is measured and accumulated in a repository. The repository becomes a knowledge base that is accessed by the algorithms and the ideal memory (bufferpool) configurations, which optimize database performance, are learned and implemented. The sampling of performance continues at regular intervals and the knowledge base continues to grow. As knowledge continues to accumulate, the algorithms are forbidden from becoming complacent. The ideal bufferpool memory configurations are regularly reevaluated to ensure they continue to be optimal given potential changes in the database's use or access patterns. The entire method can be coded in a machine language and automated; minimal intervention from administration staff is required thus freeing these valuable resources for other business objectives. Most significantly, the techniques employed would ordinarily be very time consuming and prone to error if not automated, but the performance and productivity gains to be realized are potentially substantial. This method then seeks to remove a barrier to optimal database performance by deploying a self-learning, automated process.

It is, therefore, apparent that there has been provided, in accordance with the present invention, a method and apparatus for automated bufferpool tuning. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A heuristic method for the automated tuning of bufferpool size in a computer database, comprising the steps of:
automatically characterizing the types of database access;
automatically collecting data base access and usage data based upon a predefined schedule; and
using the types of database access characterized and database access and usage data, optimizing the allocation of bufferpool memory so as to ensure optimal access time and to minimize disk thrashing.

2. The method of claim 1, wherein said step of automatically collecting data base access and usage data includes collecting data relating to database access and usage, wherein the data is selected from at least one of the group consisting of:
time of day;
day of week;
usage patterns;
users; and
jobs.

3. The method of claim 1, wherein said step of optimizing the allocation of bufferpool memory further determines the optimal settings for a hit index and overall hits and adjusts for variances between characteristics of a predominant access type.

4. The method of claim 1, further including the step of repeating the steps of claim 1 on a regular basis.

5. The method of claim 3, further including the step of storing data collected during a plurality of cycles of executing the steps of claim 1 in a historical database, and wherein the step of optimizing the allocation of bufferpool memory includes access to the historical database.

6. A heuristic method for automated bufferpool tuning in a computer, comprising the steps of:
automatically identifying types of access;
automatically recalibrating the bufferpool sized based upon historical data, including time of day and day of week usage patterns stored in a historical usage database; and
optimizing the allocation of computer memory to ensure optimal access time.

7. The method of claim 6, wherein the step of optimizing the allocation of computer memory further includes determining the optimal settings for INDEX hits and OVERALL hits, and incorporating said variables in a determination of the optimal memory allocation.

8. The method of claim 6, wherein the step of optimizing the allocation of computer memory further includes adjusting the allocation for variances between different access types.

9. The method of claim 6, wherein the historical data includes data relative to specific jobs, users, specific times, and usage patterns, and where the step of optimizing the allocation of computer memory includes optimizing a bufferpool for specific jobs and users in accordance with a predicted usage pattern.

10. In a database, a bufferpool tuning process, comprising the steps of:
deploying self-executing program to monitor and collect data relating to the performance of a database bufferpool, including access data and tablespace size;
combining the tablespace size and access attributes, to track historical performance; and
tuning the bufferpool in response to the historical performance.
